(19) United States
(12) Patent Application Publication
(10) Pub. No.: US 2021/0163671 A1
(43) Pub. Date: Jun. 3, 2021

(54) METHOD FOR PREPARING COMPOUNDS WITH AN ALKOXYSILYL GROUP

(71) Applicants: BOSTIK SA, Colombes (FR); CENTRE NATIONAL DE LA RECHERCHE SCIENTIFIQUE, Paris (FR); UNIVERSITE DE RENNES 1, Rennes Cedex (FR)

(72) Inventors: Frederic SIMON, Venette (FR); Stephane FOUQUAY, Venette (FR); Guillaume MICHAUD, Venette (FR); Cyril CHAUVEAU, Venette (FR); Jean-Francois CARPENTIER, Acigne (FR); Sophie GUILLAUME, Vitre (FR)

(73) Assignees: BOSTIK SA, Colombes (FR); CENTRE NATIONAL DE LA RECHERCHE SCIENTIFIQUE, Paris (FR); UNIVERSITE DE RENNES 1, Rennes Cedex (FR)

(21) Appl. No.: 17/263,475

(22) PCT Filed: Jul. 19, 2019
(86) PCT No.: PCT/FR2019/051814

§ 371 Date: Jan. 26, 2021

(30) Foreign Application Priority Data
Jul. 27, 2018 (FR) 1857003

(51) Int. Cl. C08G 18/76; C09J 175/16; C08G 18/81; C08G 18/67; C08G 18/48; C08G 18/10

(52) U.S. Cl. CPC C08G 18/7621; C09J 175/16; C08G 18/10; C08G 18/672; C08G 18/4845; C08G 18/8116

(57) ABSTRACT

Method for preparing a compound having an alkoxysilyl group of formula (I), wherein X represents —O— or —NR⁴— with R⁴═H or C₁-C₄alkyl; R¹ is a radical having from 1 to 20 carbon atoms; R² and R³ are a C₁-C₄ alkyl radical; p is an integer equal to 0, 1 or 2; comprising a cross metathesis reaction in the presence (i) of a compound having a group of acrylate type and of formula: —X(C═O)—CH═CH₂, (ii) of an α-olefinic silane of formula (II): and (iii) of a metathesis catalyst chosen from GRUBBS catalysts and 2nd generation HOVEYDA-GRUBBS (HG2) catalysts. 2) Compound having said alkoxysilyl group, obtained by the method 1).

The subject of the present invention is a process for preparing compounds comprising an alkoxysilyl group, in particular comprising an alkoxysilyl end group, and more particularly polymers comprising an alkoxysilyl end group. The invention also relates to the novel compounds thus prepared.

Polymers and other compounds comprising alkoxysilyl end groups are well known in the field of adhesives and sealants.

Indeed, the adhesive compositions which comprise such a polymer in combination with a catalyst and optionally a filler can be applied in a thin layer on at least one of two substrates to be assembled.

A polymer comprising alkoxysilyl end groups reacts, at ambient temperature, by crosslinking in the presence of water (coming from the surrounding medium and/or from the substrates), which results in the formation of a cohesive adhesive seal ensuring the sturdiness of the assembly of these two substrates. This adhesive seal consists mainly of said polymer crosslinked in a three-dimensional network which is formed by the polymer chains linked together by bonds of siloxane type. The crosslinking may take place before or after the two substrates are brought into contact and the application, where appropriate, of pressure at their faying surface.

Compounds comprising alkoxysilyl end groups other than a polymer can also be used in the field of adhesives and sealants as adhesion promoters, a crosslinking agent or also a water scavenger.

Polyethers comprising alkoxysilyl end groups are widely available commercially, in particular from the company Kaneka under the name MS Polymers for “Modified Silane Polymers”.

A well-known process for preparing such polyethers comprising alkoxysilyl end groups comprises the production of a polyether comprising OH end groups, the conversion of said groups to olefin, and the hydrosilylation of end allyl double bonds in the presence of a platinum catalyst.

Bostik application WO 2009/106699 also describes a process for preparing a polyether-polyurethane comprising alkoxysilyl end groups, which comprises reacting an isocyanatosilane with a polyether-polyurethane comprising 2 —OH end groups.

A process for preparing a polyether-polyurethane comprising alkoxysilyl end groups, which comprises reacting an aminosilane with a polyether-polyurethane comprising two —NCO end groups, is also known, in particular from Bostik application EP 2583988.

However, it is always desirable to enrich the routes of access to compounds comprising alkoxysilyl end groups, and to make available to the formulator of adhesive compositions and mastic, new compounds comprising alkoxysilyl end groups which may be included in said compositions and which may improve solutions to the many practical problems of adhesive bonding that are encountered by end users.

The aim of the present invention is thus to provide a new process for preparing compounds, in particular polymers, having at least one alkoxysilyl group.

It also aims to provide new compounds comprising alkoxysilyl end groups obtained by said process.

The present invention relates first and foremost to a process for preparing a compound (A) comprising at least one alkoxysilyl group F of formula (I):

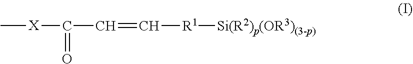

wherein:
X represents —O— or the group —NR⁴— wherein R⁴ represents a hydrogen atom or an alkyl radical comprising from 1 to 20 carbon atoms, preferably from 1 to 4 carbon atoms;
R¹ is a linear or branched, saturated or unsaturated hydrocarbon-based radical comprising from 1 to 20 carbon atoms, preferably from 1 to 9 carbon atoms and even more preferentially from 1 to 2 carbon atoms;
R² represents a linear or branched alkyl radical comprising from 1 to 4 carbon atoms, with the possibility that, when there are several radicals R², these radicals are identical or different;
R³ represents a linear or branched alkyl radical comprising from 1 to 4 carbon atoms, with the possibility that, when there are several radicals R³, these radicals are identical or different, and with the possibility, in addition, that two groups OR³ may be engaged in the same ring;
p is an integer equal to 0, 1 or 2, preferably equal to 0 or 1; and

said process comprising a cross-metathesis reaction in the presence of:

(i) a compound (B) comprising at least one acrylate or acrylamide group F′ of formula (I′):

—X(C═O)—CH═CH₂ (I′)

wherein X is as defined above;

(ii) an α-olefinic silane (C) of formula (II):

H₂C═CH—R¹—Si(R²)ₚ(OR³)₍₃₋ₚ₎ (II);

wherein R¹, R² and R³ are as defined above; and

(iii) a metathesis catalyst (D) chosen from the 2^{nd}-generation Grubbs catalyst (G2) of formula:

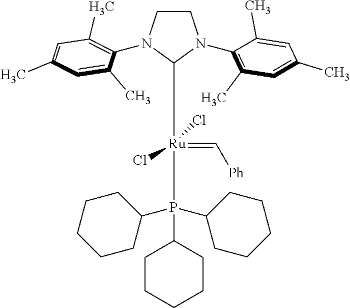

and the 2^{nd}-generation Hoveyda-Grubbs catalyst (HG2) of formula:

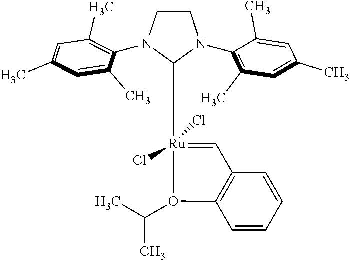

It has in fact been found that said process makes it possible to convert the acrylate or acrylamide group F′ of the compound (B) into an alkoxysily group F of formula (I) with a high degree of conversion, generally greater than 70%.

The letters used to name the generic radicals and groups which appear in the various formulae above retain, in the present text, the same definition as given above, unless otherwise indicated.

I—Polymer Compound (A) and Corresponding Precursor Polymer (B):

According to a 1 embodiment, the compound (A) is a polymer of which the main chain is chosen:
when X is —O—, from a polyether, a polyester, a polyene, a poly(meth)acrylate or a polyurethane; and
when X is the group —NR⁴—, from a polyether, a polyene, a poly(meth)acrylate or a polyurethane;
   and which comprises at least one group F of formula (I), which is preferably an end group, preferentially at least 2 end groups F of formula (I), and even more preferentially 2 end groups F of formula (I).

Said polymer (A) is then advantageously obtained from a polymer (B) of which the main chain is identical to that of the polymer (A) and which comprises at least one group F′ of formula (I′), which is preferably an end group, preferentially at least 2 groups F′ of formula (I′), and even more preferentially 2 end groups F′ of formula (I′).

The term “polymer” is intended to mean a compound of which the main chain consists of the repetition of at least 2 monomer units (or repeating units) and of which the molar mass, measured for example by NMR or mass spectrometry, is between 1000 and 50 000 g/mol. The term “end group” is intended to mean a group located at one of the ends of the main chain.

The polymer comprising an alkoxysilyl end group (A), and also the precursor polymer (B), has an average molar mass ranging from 1000 to 50 000 g/mol, preferably from 1000 to 40 000 g/mol, and more preferably from 1000 to 30 000 g/mol. The average molar mass of the polymers can be measured by methods well-known to those skilled in the art, for example by NMR, mass spectrometry and size exclusion chromatography using standards of the polystyrene type.

When the main chain of the polymers (B) and (A) consists of a polyurethane, the latter is advantageously chosen from a polyether-polyurethane, a polyester-polyurethane, a polyether-polyester-polyurethane, a polyene-polyurethane, a polyether-polyene-polyurethane or a poly(meth)acrylate-polyurethane.

1. Preparation of a Polymer (B) Comprising at Least 1 Acrylate End Group (F′ of Formula (I′) Wherein X is —O—):

1.1. Preparation of Said Polymer (B), the Main Chain of which is Chosen from a Polyether, a Polyester, a Polyene or a Poly(Meth)Acrylate:

Said polymer (B) is prepared by reacting at least one polyol which is chosen from:
a polyether polyol (preferably a polyether diol or triol);
a polyester polyol (preferably a polyester diol);
a polyene polyol (preferably a polyene diol); or
a poly(meth)acrylate polyol (preferably a poly(meth)acrylate diol);

with either acrylic acid chloride, or acrylic anhydride or also an isocyanatoalkyl acrylate in amounts such as the respective mole ratio OH/—C(═O)C, OH/[—C(═O)—]₂—O— or else OH/NCO is less than or equal to 1, preferably ranges from 0.90 to 1.00, more preferably from 0.95 to 1.00, and even more preferentially is equal to 1.

Reference is made for a description of this reaction to UCB patent application EP 0992480 and Merck patent application U.S. Pat. No. 6,602,963. The isocyanatoalkyl acrylate is described later in the text, in section 1.2.2.

The polyol(s) used for preparing said polymer (B) may be chosen from those of which the number-average molecular weight (Mn) ranges from 1000 to 40 000 g/mol, preferably from 1000 to 30 000 g/mol and even more preferentially from 1000 to 22 000 g/mol.

Preferably, their hydroxyl functionality ranges from 1 to 6, preferentially from 2 to 3. The hydroxyl functionality is the mean number of hydroxyl functions per mole of polyol.

In the case of a hydroxyl functionality equal to 2, the —OH groups are preferentially located at the 2 ends of the main chain of the polymer.

Preferably, the polyol(s) that may be used according to the invention have a hydroxyl number (OHN) ranging from 1 to 337 milligrams of KOH per gram of polyol (mg KOH/g), preferably from 2 to 337 mg KOH/g more preferably from 3 to 337 mg KOH/g.

According to a particular embodiment, the hydroxyl number of polyol(s) having a hydroxyl functionality of 2 ranges from 2 to 112 mg KOH/g, preferably from 3 to 112 mg KOH/g, more preferably from 5 to 112 mg KOH/g.

According to one particular embodiment, the hydroxyl number of polyol(s) having a hydroxyl functionality of 3 ranges from 4 to 168 mg KOH/g, preferably 5 to 168 mg KOH/g, more preferably from 7 to 168 mg KOH/g.

The hydroxyl number (OHN) of a polyol is the number of moles of —OH functions present per gram of said polyol, expressed in the form of the equivalent number of milligrams of KOH, measured experimentally, to neutralize the acetic acid which combines with 1 gram of said polyol by an acetylation reaction.

The polyol(s) which can be used can be chosen from aromatic polyols, aliphatic polyols, arylaliphatic polyols and the mixtures of these compounds.

Polymers (B) comprising at least 2 acrylate end groups and in which the main chain is chosen from a polyether, a polyester, a polyene or a poly(meth)acrylate are also commercially available.

Mention may be made, for example, of liquid poly(propylene) glycol diacrylates having a number-average molecular weight (Mn) of from 1000 to 4000 g/mol available from Advanced Organic Synthesis of the following formula:

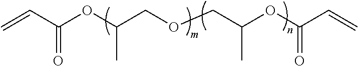

Mention may also be made, as diacrylate polyesters, of CN2203 (Mn=3400 g/mol) and CN2505 (Mn=1000 g/mol) available from Sartomer.

Mention may also be made of the unsaturated liquid poly(butadiene) diacrylates having a number-average molecular weight (Mn) ranging from 1400 to 3000 g/mol available from Osaka Organic Chemical Industry or San Esters under the trade references BAC-15 and BAC-45 and of the following formula:

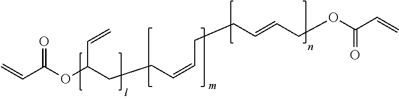

and also the saturated poly(butadiene) diacrylate equivalents available from Sartomer.

Mention may also be made, for example, of unsaturated liquid poly(isoprene) diacrylates of the following formula:

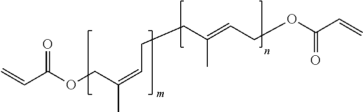

wherein m and n are integers such that the number-average molecular weight ranges from 1000 to 10 000 g/mol, preferably from 1000 to 5000 g/mol;
and also the saturated poly(isoprene) diacrylate equivalents commercially available from Osaka Organic Chemical Industry under the trade reference Spida.

Mention may also be made of the alkoxylated poly(butadiene) diacrylate derivatives described in application WO 2007/090634 from Cray Valley of formula:

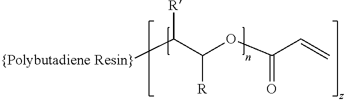

wherein R═H, Me, Et, Bu or Phenyl, R′ ═H or Me, n=1 to 100 and z=1 to 3.

Among the saturated or unsaturated polyolefin diols that can be used for the synthesis, mention may finally be made of the commercial references Poly BD, Poly IP and Epol from Idemitsu Kosan.

1.1.1. Polyester Polyols:

According to the invention, the polyester polyol(s) may have a number-average molecular weight ranging from 1000 g/mol to 10 000 g/mol, preferably from 1000 g/mol to 6000 g/mol.

The polyester polyols may be chosen from polyester diols and polyester triols, and preferably from polyester diols.

Among the polyester polyols, examples that may be mentioned include:
polyester polyols of natural origin, such as castor oil;
polyester polyols resulting from the polycondensation:
   of one or more aliphatic (linear, branched or cyclic) or aromatic polyols, such as, for example, monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer and mixtures thereof, with
   one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer and the mixtures of these acids, an unsaturated anhydride, such as, for example, maleic or phthalic anhydride, or a lactone, such as, for example, caprolactone;
estolide polyols resulting from the polycondensation of one or more hydroxy acids, such as ricinoleic acid, with a diol (examples that may be mentioned include Polycin® D-1000 and Polycin® D-2000 available from Vertellus).

The abovementioned polyester polyols can be prepared conventionally and are for the most part commercially available.

Mention may be made, among polyester polyols, for example, of the following products with a hydroxyl functionality equal to 2:
Tone® 0240 (sold by Union Carbide), which is a polycaprolactone with a number-average molecular weight of approximately 2000 g/mol and a melting point of approximately 50° C.,
Dynacoll® 7381 (sold by Evonik) with a number-average molecular weight of approximately 3500 g/mol and having a melting point of approximately 65° C.,
Dynacoll® 7360 (sold by Evonik), which results from the condensation of adipic acid with hexanediol and has a number-average molecular weight of approximately 3500 g/mol and a melting point of approximately 55° C.,
Dynacoll® 7330 (sold by Evonik) with a number-average molecular weight of approximately 3500 g/mol and having a melting point of approximately 85° C.,
Dynacoll® 7363 (sold by Evonik), which also results from the condensation of adipic acid with hexanediol and has a number-average molecular weight of approximately 5500 g/mol and a melting point of approximately 57° C.,
Dynacoll® 7250 (sold by Evonik): polyester polyol having a viscosity of 180 Pa·s at 23° C., a number-average molecular weight Mn equal to 5500 g/mol and a T_{g} equal to −50° C.,
Kuraray® P-6010 (sold by Kuraray): polyester polyol having a viscosity of 68 Pa·s at 23° C., a number-average molecular weight Mn equal to 6000 g/mol and a T_{g} equal to −64° C.,
Kuraray® P-10010 (sold by Kuraray): polyester polyol having a viscosity of 687 Pa·s at 23° C. and a number-average molecular weight Mn equal to 10 000 g/mol,
Realkyd® XTR 10410 (sold by Cray Valley): polyester polyol with a number-average molecular weight Mn in the region of 1000 g/mol and the hydroxyl number of which ranges from 108 to 116 mg KOH/g. It is a product resulting from the condensation of adipic acid, diethylene glycol and monoethylene glycol,
Dekatol® 3008 (sold by Bostik) with a number-average molar mass Mn in the region of 1060 g/mol and the hydroxyl number of which ranges from 102 to 112 mg KOH/g. It is a product resulting from the condensation of adipic acid, diethylene glycol and monoethylene glycol.

1.1.2 Polyether Polyols:

According to the invention, the polyether polyol(s) can have a number-average molecular weight ranging from 1000 to 30 000 g/mol, preferably from 1000 to 20 000 g/mol.

The polyether polyol(s) which can be used according to the invention is (are) preferably chosen from polyoxyalkylene polyols, the linear or branched alkylene part of which comprises from 1 to 4 carbon atoms, more preferentially from 2 to 3 carbon atoms.

More preferentially, the polyether polyol(s) which can be used according to the invention is (are) preferably chosen from polyoxyalkylene diols or polyoxyalkylene triols, the linear or branched alkylene part of which comprises from 1 to 4 carbon atoms, more preferentially from 2 to 3 carbon atoms.

Mention may be made, as examples of polyoxyalkylene diols or triols which can be used according to the invention, of:
polyoxypropylene diols or triols (also denoted by polypropylene glycol (PPG) diols or triols) having a number-average molecular weight (Mn) ranging from 1000 to 12 000 g/mol;
polyoxyethylene diols or triols (also denoted by polyethylene glycol (PEG) diols or triols) having a number-average molecular weight (Mn) ranging from 1000 to 18 000 g/mol;
and mixtures thereof.

The abovementioned polyether polyols can be prepared conventionally and are widely available commercially. They can be obtained by polymerization of the corresponding alkylene oxide in the presence of a basic catalyst (for example potassium hydroxide) or of a catalyst based on a double metal/cyanide complex.

By way of example of polyether diols, mention may be made of the polyoxypropylene diols sold under the name Acclaim® 2220, 4200, 8200, 12200 and 18200 by Covestro, with a number-average molecular weight (Mn) ranging from 2000 at 22 000 g/mol and the hydroxyl number of which ranges from 5 to 58 mg KOH/g.

Mention may be made, as an example of polyether triols, of the polyoxypropylene triol sold under the name Voranol CP3355 by Dow, with a number-average molecular weight in the vicinity of 3554 g/mol.

1.1.3. Polyene Polyols:

The polyene polyol(s) which can be used according to the invention can preferably be chosen from polyenes comprising hydroxyl end groups, and their corresponding hydrogenated or epoxidized derivatives. Said polyenes can have a number-average molecular weight ranging from 1000 to 10 000 g/mol, and preferably from 1000 to 5000 g/mol.

Preferably, the polyene polyol(s) that may be used according to the invention is (are) chosen from polybutadienes including hydroxyl end groups, which are optionally hydrogenated or epoxidized. Preferentially, the polyene polyol(s) which can be used according to the invention is (are) chosen from butadiene/isoprene homopolymers and copolymers comprising hydroxyl end groups, which are optionally hydrogenated or epoxidized.

In the context of the invention, and unless otherwise mentioned, the term “hydroxyl end groups” of a polyene polyol is understood to mean the hydroxyl groups located at the ends of the main chain of the polyene polyol.

The abovementioned hydrogenated derivatives can be obtained by complete or partial hydrogenation of the double bonds of a polydiene comprising hydroxyl end groups, and are thus saturated or unsaturated.

The abovementioned epoxidized derivatives can be obtained by chemoselective epoxidation of the double bonds of the main chain of a polyene comprising hydroxyl end groups, and thus comprise at least one epoxy group in their main chain.

Mention may be made, as examples of polyene polyols, of saturated or unsaturated butadiene homopolymers comprising hydroxyl end groups, which are optionally epoxidized, such as, for example, those sold under the name Poly BD® or Krasol® by Cray Valley or else those sold by Idemitsu Kosan.

Mention may be made, as examples of polyene polyols, of saturated or unsaturated isoprene homopolymers comprising hydroxyl end groups, such as, for example, those sold under the name Poly IP™ or Epol™ by Idemitsu Kosan.

1.1.4. Poly(Meth)Acrylate Polyols

The poly(meth)acrylate polyol(s), which can be used according to the invention can have a number-average molecular weight ranging from 1000 to 22 000 g/mol, preferably from 1000 to 10 000 g/mol, and even more preferentially from 1000 to 6000 g/mol.

The poly(meth)acrylate polyol(s) which can be used according to the invention is (are) preferably chosen from homopolymers, copolymers and terpolymers of acrylate and/or methacrylate monomer(s).

More preferentially, the poly(meth)acrylate polyol(s) which can be used according to the invention is (are) preferably chosen from poly(meth)acrylate diols and poly(meth)acrylate triols (telechelic).

By way of example of poly(meth)acrylate polyols which can be used for the synthesis of said polymer (B), mention may be made, for example, of the poly(meth)acrylate diols of the following formula:

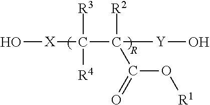

which is described, with the corresponding generic radicals, in U.S. Pat. No. 6,943,213 from Acushnet. Such poly(meth)acrylate diols are available under the trade references Tego® Diol MD-1000, BD-1000, BD-2000 and OD-2000 from Evonik Tego Chimie.

1.2. Preparation of a Polymer (B) Comprising at Least 2 Acrylate End Groups (F′of Formula (I′) Wherein X is —O—), and the Main Chain of which is a Polyurethane:

Said polyurethane (B) can be obtained by reacting:
according to a 1^{st} implementation variant 1.2.1., a polyurethane comprising at least two —OH end functions with at least the acrylic acid chloride; or else
according to a 2^{nd} implementation variant 1.2.2., a polyurethane comprising at least two —OH end functions with at least one isocyanatoalkyl acrylate; or else
according to a 3^{rd} implementation variant 1.2.3., a polyurethane comprising at least two —NCO end functions with at least one hydroxylated ester of acrylic acid.

Implementation Variant 1.2.1.:

According to implementation variant 1.2.1., the polyurethane (B) is prepared according to a process comprising the following steps:
E_{1.2.1.}¹) the preparation of polyurethane comprising OH end groups by a polyaddition reaction:
   a) of at least one polyisocyanate, preferably chosen from diisocyanates and mixtures thereof;
   b) with at least one polyol, preferably chosen from polyester polyols, polyether polyols, polyene polyols, poly(meth)acrylate polyols and mixtures thereof,
in amounts such that the NCO/OH mole ratio (r1) is strictly less than 1, preferably ranges from 0.2 to 0.8 and preferentially ranges from 0.3 to 0.5;

and
E_{1.2.1.}²) the reaction of the product formed at the end of step E_{1.2.1.}¹) with acrylic acid chloride, in amounts such that the OH/—C(═O)Cl mole ratio (r2) is less than or equal to 1, preferably ranges from 0.90 to 1.00, more preferably from 0.95 to 1.00, and even more preferentially is equal to 1.

The NCO/OH mole ratio (r1) corresponds to the mole ratio of the number of isocyanate groups (NCO) to the number of hydroxyl groups (OH) borne by all the polyisocyanate(s) and polyol(s) present in the reaction medium of step E_{1.2.1.}¹).

The OH/—C(═O)Cl mole ratio (r2) corresponds to the mole ratio of the number of hydroxyl groups (OH) to the number of —C(═O)—Cl (acid chloride) groups borne respectively by the combination:
of the alcohol compounds (polyurethane comprising —OH end groups obtained at the end of step E_{1.2.1.}¹) and optionally the unreacted polyol(s) at the end of step E_{1.2.1.}¹)), and
of the acrylic acid chloride present in the reaction medium of step E_{1.2.1.}²).

In accordance with said variant, the group F′ of the polyurethane (B) obtained then corresponds to formula (I′)-1:

—O(C═O)—CH═CH₂ (I)-1

and the group F of the polyurethane (A) obtained by the process according to the invention corresponds to formula (I)-1:

—O(C═O)—CH═CH—R¹—Si(R²)ₚ(OR³)₍₃₋ₚ₎ (I)-1

Implementation Variant 1.2.2.:

According to implementation variant 1.2.2., the polyurethane (B) can be obtained by reacting a polyurethane comprising at least two —OH end functions with at least one isocyanatoalkyl acrylate. Preferably, said polyurethane (B) is prepared by a process comprising the following steps:
E_{1.2.2.}¹) the preparation of a polyurethane comprising OH end groups by a polyaddition reaction:
   (a) of at least one polyisocyanate, preferably chosen from diisocyanates and mixtures thereof;
   (b) with at least one polyol, preferably chosen from polyester polyols, polyether polyols, polyene polyols, poly(meth)acrylate polyols and mixtures thereof;
in amounts such that the NCO/OH mole ratio (r1) is strictly less than 1, preferably ranges from 0.2 to 0.8 and preferentially ranges from 0.3 to 0.5;

and
E_{1.2.2.}²) the reaction of the product formed at the end of step E_{1.2.2.}¹) with at least one isocyanatoalkyl acrylate, in amounts such that the OH/NCO mole ratio (r3) is less than or equal to 1, preferably ranges from 0.90 to 1.00, more preferably from 0.95 to 1.00, and even more preferentially is equal to 1.

The NCO/OH mole ratio (r1) corresponds to the mole ratio of the number of isocyanate groups (NCO) to the number of hydroxyl groups (OH) borne by all the polyisocyanate(s) and polyol(s) present in the reaction medium of step E_{1.2.2.}¹).

The OH/NCO mole ratio (r3) corresponds to the mole ratio of the number of hydroxyl groups (OH) to the number of isocyanate groups (NCO) borne, respectively, by the combination:
of the alcohol compounds (polyurethane comprising —OH end groups obtained at the end of step E_{1.2.2.}¹) and optionally the unreacted polyol(s) at the end of step E_{1.2.2.}¹)), and
of the isocyanatoalkyl acrylate present in the reaction medium of step E_{1.2.2.}²).

The isocyanatoalkyl acrylate used in the preparation of the polyurethane (B) according to implementation variant 1.2.2. can be, according to a more preferred variant, represented by the following formula (IV):

CH₂═CH—(C═O)—O—R^{O}—NCO (IV)

wherein R^{O} represents a linear or branched, aliphatic or cyclic, saturated or unsaturated divalent hydrocarbon-based radical, preferably comprising from 2 to 24 carbon atoms, and being optionally interrupted by one or more heteroatoms (such as for example N, O, S, and in particular O).

The isocyanatoacrylates of formula (IV) can in particular be obtained, according to one of the procedures described in Showa Denko patent application JP 6025476, from aminoalcohols, cyclic urethanes and methyl acrylate without the use of phosgene.

Among the isocyanatoacrylates of formula (IV), mention may be made, for example, of 2-isocyanatoethyl acrylate (CAS number: 13641-96-8) available from Showa Denko Europe.

In accordance with said variant, the group F′ of the polyurethane obtained then corresponds to formula (I′)-2:

—O(C═O)—NH—R^{O}—O(C═O)—CH═CH₂ (I′)-2

and the group F of the polyurethane (A) obtained by the process according to the invention corresponds to formula (I)-2:

—O(C═O)—NH—R^{O}—O(C═O)—CH═CH—R¹—Si(R²)ₚ(OR³)₍₃₋ₚ₎ (I)-2

According to one preferred embodiment, R^{O} represents a linear or branched, aliphatic or cyclic, saturated or unsaturated divalent alkylene radical, comprising from 2 to 24 carbon atoms, preferably from 2 to 18, preferentially from 2 to 14, even more preferentially from 2 to 10 and advantageously from 2 to 6 carbon atoms.

Implementation Variant 1.2.3.:

According to implementation variant 1.2.3., the polyurethane (B) can be obtained by reacting a polyurethane comprising at least two —NCO end functions with at least one hydroxylated ester of acrylic acid. Preferably, said polyurethane (B) is prepared by a process comprising the following steps:
E_{1.2.3.}¹) the preparation of a polyurethane comprising NCO end groups by a polyaddition reaction:
   (a) of at least one polyisocyanate, preferably chosen from diisocyanates and mixtures thereof;
   (b) with at least one polyol, preferably chosen from polyester polyols, polyether polyols, polyene polyols, poly(meth)acrylate polyols and mixtures thereof;
in amounts such that the NCO/OH mole ratio (r4) is strictly greater than 1, preferably ranges from 1.3 to 2.0 and preferentially ranges from 1.5 to 1.7;

and
E_{1.2.3.}²) the reaction of the product formed at the end of step E_{1.2.3.}¹) with at least one hydroxylated ester of acrylic acid, in amounts such that the OH/NCO mole ratio (r5) is less than or equal to 1, preferably ranges from 0.90 to 1.00, more preferably from 0.95 to 1.00, and even more preferentially is equal to 1.

The NCO/OH mole ratio (r4) corresponds to the mole ratio of the number of isocyanate groups (NCO) to the number of hydroxyl groups (OH) borne, respectively, by all the polyisocyanate(s) and polyol(s) present in the reaction medium of step E_{1.2.3.}¹).

When the polyurethane bearing NCO end groups is obtained during step E_{1.2.3.}¹) from a mixture of polyisocyanates or from several polyisocyanates added successively, the calculation of the ratio (r4) takes into account, on the one hand, the NCO groups carried by all of the polyisocyanate(s) present in the reaction medium of step E_{1.2.3.}¹) and, on the other hand, the OH groups borne by the polyol(s) present in the reaction medium of step E_{1.2.3.}¹).

The OH/NCO mole ratio (r5) corresponds to the mole ratio of the number of hydroxyl groups (OH) to the number of isocyanate groups (NCO) borne, respectively:
by the hydroxylated ester of acrylic acid, and
by the isocyanate(s) (especially polyurethane comprising NCO end groups and optionally unreacted polyisocyanate(s) at the end of step E_{1.2.3.}¹)) present in the reaction medium of step E_{1.2.3.}²).

The hydroxylated ester of acrylic acid used in the preparation of the polyurethane (B) according to implementation variant 1.2.3. can be, according to a more preferred variant, represented by the following formula (V):

CH₂═CH—C(═O)—O—R^{O}—OH (V)

wherein R^{O} represents a linear or branched, aliphatic or cyclic, saturated or unsaturated divalent hydrocarbon-based radical, preferably comprising from 2 to 24 carbon atoms, and being optionally interrupted by one or more heteroatoms (such as for example N, O, S, and in particular O) or an ester function.

The hydroxylated ester of formula (V) can in particular be obtained according to one of the procedures described in patent application EP 1939231 from Mitsui Chemicals Polyurethanes, by polymerization addition of ethylene oxide, of propylene oxide or of butylene oxide on acrylic acid in the presence of a catalyst of phosphazenium type.

Among the hydroxylated esters of acrylic acid of formula (V), examples that may be mentioned include 2-hydroxyethyl acrylate (HEA), 2-hydroxypropyl acrylate (HPA), 4-hydroxybutyl acrylate (4-HBA) and 2-hydroxybutyl acrylate (HBA) (which are available, for example, from Sartomer, Cognis or BASF), polycaprolactone acrylate SR 495B (CAPA) available from Sartomer or hydroxyethylcaprolactone acrylate (HECLA) available from BASF.

Mention may be made, among the ethoxylated and/or propoxylated derivatives of 25 acrylic acid of formula (V) mentioned above, for example, of Blemmer® AP-150, Blemmer® AP-200, Blemmer® AP-400, Blemmer® AP-550, Blemmer® AP-800, Blemmer® AP-1000, Blemmer® AE-90, Blemmer® AE-150, Blemmer® AE-200, Blemmer® AE-350 or Blemmer® AE-400, available from Nippon Oil & Fats Corporation, or SR 604 available from Sartomer.

In accordance with said variant, the group F′ of the polyurethane (B) obtained then corresponds to formula (I′)-3:

—NH(C═O)—O—R′^{O}—O(C═O)—CH═CH₂ (I′)-3

and the group F of the polyurethane (A) obtained by the process according to the invention corresponds to formula (I)-3:

—NH(C═O)—O—R′^{O}—O(C═O)—CH═CH—R¹—Si(R²)ₚ(OR³)₍₃₋ₚ₎ (I)-3

According to an even more preferred embodiment, R^{O} represents a linear or branched, aliphatic or cyclic, saturated or unsaturated divalent alkylene radical, comprising from 2 to 24 carbon atoms, preferably from 2 to 18, preferentially from 2 to 14, even more preferentially from 2 to 10 and advantageously from 2 to 6 carbon atoms.

1.2.4. Polyols Used in Implementation Variants 1.2.1., 1.2.2. And 1.2.3.:

The polyols used for the preparation of a polyurethane (B), in accordance with the 3 implementation variants 1.2.1, 1.2.2. and 1.2.3. of point 1.2., can be chosen from those of which the number-average molecular weight (Mn) ranges from 62 to 40 000 g/mol, preferably from 200 to 30 000 g/mol, and even more preferentially from 400 to 22 000 g/mol.

Preferably, their hydroxyl functionality ranges from 2 to 6, preferentially from 2 to 3. The hydroxyl functionality is the mean number of hydroxyl functions per mole of polyol.

Preferably, the polyol(s) that can be used according to the invention have a hydroxyl number (OHN) (average) ranging from 2 to 1848 milligrams of KOH per gram of polyol (mg KOH/g), preferably from 3 to 842 mg KOH/g more preferably from 5 to 337 mg KOH/g.

According to a particular embodiment, the hydroxyl number of the polyols having a hydroxyl functionality of 3 ranges from 4 to 1828 mg KOH/g, preferably from 5 to 842 mg KOH/g, more preferably from 7 to 421 mg KOH/g.

According to a particular embodiment, the hydroxyl number of polyol(s) having a hydroxyl functionality of 2 ranges from 2 to 1810 mg KOH/g, preferably from 3 to 561 mg KOH/g, more preferably from 5 to 281 mg KOH/g.

The polyols that can be used can be chosen from aromatic polyols, aliphatic polyols, arylaliphatic polyols and mixtures of these compounds.

The polyols that can be used can be chosen from polyether polyols, polyester polyols, polyene polyols, poly(meth)acrylates and mixtures thereof.

The polyester polyols can have a number-average molecular weight ranging from 200 g/mol to 10 000 g/mol, preferably from 1000 g/mol to 6000 g/mol, and are, with regard to their other characteristics, as defined above in point 1.1.1.

The polyether polyol(s) may have a number-average molecular weight ranging from 200 to 30 000 g/mol, and preferably from 400 to 22 000 g/mol. The other characteristics of said polyether polylols are as defined above in point 1.1.2. However, by way of example of polyoxyalkylene diols or triols that can be used, mention may be made of:
polyoxypropylene diols or triols (also denoted by polypropylene glycol (PPG) diols or triols) having a number-average molecular weight (Mn) ranging from 400 to 22 000 g/mol;
polyoxyethylene diols or triols (also denoted by polyethylene glycol (PEG) diols or triols) having a number-average molecular weight (Mn) ranging from 400 to 22 000 g/mol;
and mixtures thereof.

As examples of commercially available polyether diols, mention may be made of the polyoxypropylene diol sold under the name Voranol® P 400 by Dow, with a number-average molecular weight (Mn) in the region of 400 g/mol and the hydroxyl number of which ranges from 250 to 270 mg KOH/g. Mention may be made of the polyoxypropylene diols sold under the name Acclaim® 2220, 4200, 8200, 12200 and 18200 by Covestro, with a number-average molecular weight (Mn) ranging from 2000 to 22 000 g/mol and the hydroxyl number of which ranges from 5 to 58 mg KOH/g.

As examples of commercially available polyether triols, mention may also be made of the polyoxypropylene diol sold under the name Voranol® CP 450 by Dow, with a number-average molecular weight (Mn) in the region of 450 g/mol and the hydroxyl number of which ranges from 370 to 396 mg KOH/g. Mention may also be made of the polyoxypropylene triol sold under the name Acclaim® 3300 by Covestro, with a number-average molecular weight (Mn) in the region of 2922 g/mol and the hydroxyl number of which ranges from 56.2 to 59.0 mg KOH/g.

The polyene polyols that can be used for the preparation of a polyurethane (B) may be preferably chosen from polyenes comprising hydroxyl end groups, and the corresponding hydrogenated or epoxidized derivatives thereof which may have a number-average molecular weight ranging from 500 to 10 000 g/mol, and preferably from 1000 to 5000 g/mol. Reference is made, for their other characteristics, to point 1.1.3.

The poly(meth)acrylate polyols that can be used for the preparation of a polyurethane (B) can have a number-average molecular weight ranging from 200 to 22 000 g/mol, preferably from 400 to 10 000 g/mol, and even more preferentially from 1000 to 6000 g/mol. Reference is also made, for their other characteristics, to point 1.1.4.

1.2.5. Polyisocyanates Used in the Implementation Variants 1.2.1., 1.2.2. And 1.2.3.:

The polyisocyanates used in said variants can be added sequentially or reacted in the form of a mixture, in steps E_{1.2.1.}¹), E_{1.2.2.}¹) or E_{1.2.3.}¹) According to one embodiment, the polyisocyanate(s) that may be used are diisocyanate(s), preferably chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), (2,5)-bis(isocyanatomethyl)bicyclo[2.2.1]heptane (2,5-NBDI), (2,6)-bis(isocyanatomethyl)bicyclo[2.2.1]heptane (2,6-NBDI), 1,3-bis(isocyanatomethyl)cyclohexane(1,3-H6-XDI), 1,4-bis(isocyanatomethyl)cyclohexane(1,4-H6-XDI), xylylene diisocyanate (XDI) (in particular m-xylylene diisocyanate (m-XDI)), toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), tetramethylxylylene diisocyanate (TMXDI) (in particular tetramethyl(meta)xylylene diisocyanate), an HDI allophanate having, for example, the following formula (Y):

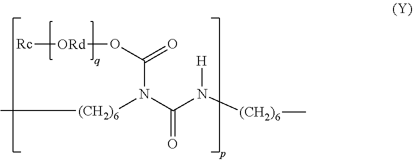

wherein p is an integer ranging from 1 to 2, q is an integer ranging from 0 to 9 and preferably 2 to 5, R_{c} represents a saturated or unsaturated, cyclic or acyclic, linear or branched hydrocarbon-based chain comprising from 1 to 20 carbon atoms, preferably from 6 to 14 carbon atoms, R_{d} represents a linear or branched divalent alkylene group containing from 2 to 4 carbon atoms, and preferably a divalent propylene group.

Preferably, the allophanate of the abovementioned formula (Y) is such that p, q, R_{c} and R_{d} are chosen such that the above HDI allophanate derivative comprises a content of isocyanate groups NCO ranging from 12% to 14% by weight relative to the weight of said derivative.

2. Preparation of a Polymer (B) Comprising at Least 1 Acrylamide End Group (F′ of Formula (I′) Wherein X is the Group —NR⁴—):

2.1. Preparation of Said Polymer (B), the Main Chain of which is a Polyether, a Polyene or a Poly(Meth)Acrylate:

Said polymer (B) is prepared by reaction of at least one polyether amine or one polyether polyamine (preferably a polyether diamine), a polyene amine or a polyene polyamine (preferably a polyolefin diamine), or else a poly(meth)acrylate polyamine (preferably a poly(meth)acrylate diamine), with acrylic acid chloride, as described in application EP 0405464 from Ajinomoto in amounts such as the NHR⁴/—C(═O Cl mole ratio is less than or equal to 1, preferably ranges from 0.90 to 1.00, more preferably from 0.95 to 1.00, and even more preferentially is equal to 1.

According to said variant, the group F′ of the polymer (B) obtained then corresponds to formula (I′)-4:

—NR⁴(C═O)—CH═CH₂ (I′)-4

and the group F of the polymer (A) obtained by the process according to the invention corresponds to formula (I)-4:

—NR⁴(C═O)—CH═CH—R¹—Si(R²)ₚ(OR³)₍₃₋ₚ₎ (I)-4

Among the polyether amines and polyether polyamines that can be used for the synthesis of said polymer (B), mention may be made, for example, of the commercial references Jeffamine M-1000, M-2005, M-2070, D-2000, D-4000, ED-2003, T-3000, T-5000 and SD-2001 from Huntsman.

Among the polyolefin diamines that can also be used for the synthesis of said polymer (B), mention may also be made of the poly(butadiene)diamines described in patent applications EP 1314744 and EP 1439194 from Cray Valley and patent application U.S. Pat. No. 4,658,062 by Atlantic Richfield.

Among the poly(meth)acrylate diamines of the structure that can be used for the synthesis of said polymers (B), mention may also be made, for example, of the poly(meth)acrylate diamines described of the following structure:

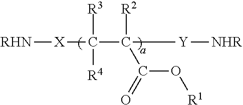

described in U.S. Pat. No. 6,943,213 from Acushnet.

2.2. Preparation of a Polymer (B) Comprising at Least 2 Acrylamide End Groups (F′ of Formula (I′) Wherein X is the Group —NR⁴—), and the Main Chain of which is a Polyurethane:

Said polyurethane (B) can be obtained by reacting a polyurethane comprising at least two —NCO end functions with at least one hydroxylated amide of acrylic acid. Preferably, said polyurethane (B) is prepared by a process comprising the following steps:
E_{2.2}¹) the preparation of a polyurethane with NCO terminations by a polyaddition reaction:
   (a) of at least one polyisocyanate, preferably chosen from diisocyanates and mixtures thereof;
   (b) with at least one polyol, preferably chosen from polyester polyols, polyether polyols, polyene polyols, poly(meth)acrylate polyols and mixtures thereof;
in amounts such that the NCO/OH mole ratio (r4) is strictly greater than 1, preferably ranges from 1.3 to 2.0 and preferentially ranges from 1.5 to 1.7;

and
E_{2.2.}²) the reaction of the product formed at the end of step E_{2.2.}¹) with at least one hydroxylated amide of acrylic acid, in amounts such that the OH/NCO mole ratio (r5) is less than or equal to 1, preferably ranges from 0.90 to 1.00, more preferably from 0.95 to 1.00, and even more preferentially is equal to 1.

The NCO/OH mole ratio (r4) and the OH/NCO mole ratio (r5) are as defined above for implementation variant 1.2.3., mutatis mutandis.

The polyester polyols, polyether polyols, polyene polyols, poly(meth)acrylate polyols and polyisocyanates, used in step E_{2.2}¹) are as defined above, respectively, in points 1.2.4. and 1.2.5.

The hydroxylated amide of acrylic acid used can be, according to a more preferred variant, represented by the following formula (VI):

CH₂═CH—C(═O)—NR⁴—R^{N}—OH (VI)

wherein:
R⁴ is as defined above; and
R^{N} represents a linear or branched, aliphatic or cyclic, saturated or unsaturated divalent hydrocarbon-based radical, preferably comprising from 2 to 24 carbon atoms, and being optionally interrupted by one or more heteroatoms (such as for example N, O, S, and in particular O) or an ester function.

The hydroxylated amide of acrylic acid of formula (VI) can in particular be obtained according to one of the procedures described in patent application U.S. Pat. No. 2,593,888 from Aniline & Film and patent application WO 2000/007002 from Ivoclar Vivadent by reaction of acryloyl chloride with an aminoalcohol derivative of formula R⁴—NH—R^{N}—OH. Among the hydroxylated amides of formula (VI), mention may be made for example of N-(2-hydroxyethyl)-N-methyl acrylamide (CAS Number: 17225-73-9) and N-(2-hydroxypropyl)-N-methylacrylamide (CAS Number: 1248069-14-8) available from Aldlab Building Blocks and Aurora Building Blocks.

In accordance with said variant 2.2., the group F′ of the polyurethane (B) obtained then corresponds to formula (I′)-5:

—NH(C═O)—O—R^{N}—NR⁴—(C═O)—CH═CH₂ (I′)-5

and the group F of the polyurethane (A) obtained by the process according to the invention corresponds to formula (I)-5:

—NH(C═O)—O—R^{N}—NR⁴—(C═O)—CH═CH—R¹—Si(R²)ₚ(OR³)₍₃₋ₚ₎ (I)-5

According to one preferred embodiment, R^{N} represents a linear or branched, aliphatic or cyclic, saturated or unsaturated divalent alkylene radical, comprising from 2 to 24 carbon atoms, preferably from 2 to 18, preferentially from 2 to 14, even more preferentially from 2 to 10 and advantageously from 2 to 6 carbon atoms.

3. General Reaction Conditions of the Processes for Preparing the Polymers (B) Comprising an Acrylate or Acrylamide End Group:

The polyaddition reactions of steps E_{1.2.1.}¹), E_{1.2.2.}¹), E_{1.2.3.}¹) and E_{2.2.}¹) included in processes 1.2. and 2.2. for preparing a polyurethane can be carried out at a temperature preferably below 95° C. and/or under preferably anhydrous conditions.

Said reactions can be carried out in the presence or absence of at least one reaction catalyst. The reaction catalyst(s) that can be used can be any catalyst known to those skilled in the art for catalyzing the formation of polyurethane by reaction of at least one polyisocyanate with at least one polyol. An amount ranging up to 0.3% by weight of catalyst(s) relative to the weight of the reaction medium of the corresponding steps can be used, preferably from 0.02% to 0.2% by weight.

In the presence of acrylic acid ester, the transesterification reaction of process 1.1. and step E_{1.2.1.}²) of process 1.2.1. can be carried out at a temperature above 110° C., preferably above 120° C. Among the esters of acrylic acid, mention may, for example, be made of methyl acrylate, butyl acrylate, propyl acrylate and pentyl acrylate.

In the presence of acrylic acid chloride, the reaction of process 1.1. and step E_{1.2.1.}²) of process 1.2.1. can be carried out at a temperature preferably below 95° C., under preferably anhydrous conditions.

In the presence of hydroxylated ester(s) of acrylic acid, or hydroxylated amide(s) of acrylic acid, the reaction of steps E_{1.2.3.}²) and E_{2.2.}²) can be carried out at a temperature preferably below 95° C., under preferably anhydrous conditions.

The hydroxylated esters of acrylic acid may be used either pure or in the form of a mixture of different hydroxylated esters of acrylic acid with a mean hydroxyl number of said mixture ranging from 9 to 483 mg KOH/g of said mixture.

The hydroxylated amides of acrylic acid may be used either pure or in the form of a mixture of different hydroxylated amides of acrylic acid with a mean hydroxyl number of said mixture ranging from 9 to 487 mg KOH/g of said mixture.

According to a more particularly preferred embodiment of the process according to the invention, the polymer (A) and the precursor polymer (B) have a polyurethane as their main chain and comprise 2 end groups, respectively F of formula (I) and F′ of formula (I′), wherein X represents —O—.

According to a particularly advantageous variant of this last embodiment, said polyurethane (A) corresponds to one of formulae (VII) and (VIII):

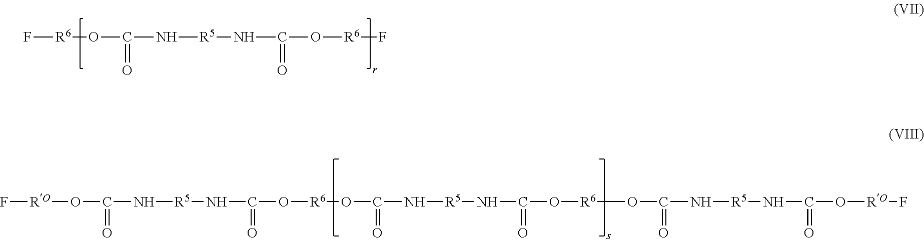

and said precursor polyurethane (B) corresponds, respectively, to one of the following formulae (VII′) and (VIII′):

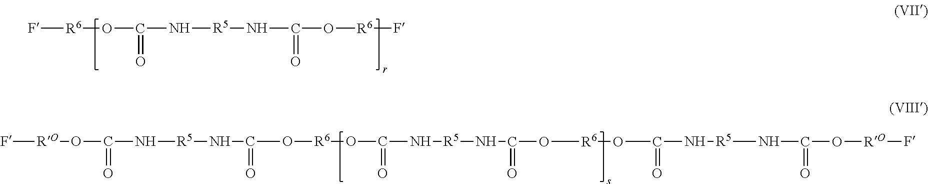

wherein:
F is the alkoxysilyl group of formula (I)-1:

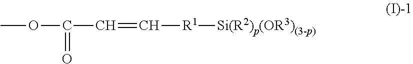

F′ is the acrylate group;
R⁵ represents a divalent hydrocarbon-based radical comprising from 5 to 15 carbon atoms which can be aromatic or aliphatic and linear, branched or cyclic;
R⁶ represents a saturated or unsaturated, linear or branched divalent hydrocarbon-based radical optionally comprising one or more oxygen atoms;
R′^{O} represents a linear or branched, aliphatic or cyclic, saturated or unsaturated divalent alkylene radical comprising from 2 to 6 carbon atoms;
r is an integer greater than or equal to 0;
s is an integer strictly greater than 0.

In formula (VII), (VIII), (VII′) or (VIII′) defined above, when the radical R⁶ comprises one or more oxygen atoms, said oxygen atom(s) are not present at the end of the chain. In other words, the free valencies of the divalent radical R⁶ bonded to the oxygen atoms neighboring the polymer (B) each originate from a carbon atom. Thus, the main chain of the radical R⁶ is terminated with a carbon atom at each of the two ends, said carbon atom then having a free valency.

According to one embodiment, R⁵ is chosen from one of the following divalent radicals, of which the formulae below reveal the two free valencies:
a) the divalent radical derived from isophorone diisocyanate (IPDI):

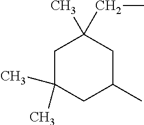

b) the divalent radical derived from dicyclohexylmethane diisocyanate (H12MDI)

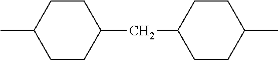

c) the divalent radical derived from toluene diisocyanate (TDI)

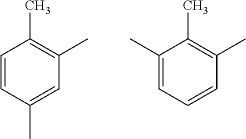

d) the divalent radicals derived from the 4,4′ and 2,4′ isomers of diphenylmethane diisocyanate (MDI)

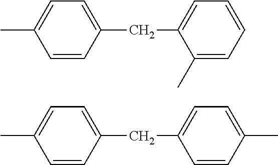

e) the divalent radical derived from hexamethylene diisocyanate (HDI)

—(CH₂)₆—
f) the divalent radical derived from m-xylylene diisocyanate (m-XDI).

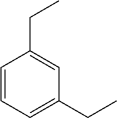

According to another embodiment, R⁶ is chosen from the following divalent radicals, of which the formulae below reveal the 2 free valences, wherein q represents an integer such that the number-average molecular weight of the radical R⁶ ranges from 200 g/mol to 30 000 g/mol, preferably from 400 g/mol to 22 000 g/mol:
derived from a polypropylene glycol of formula:

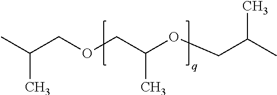

derived from a polyester diol of formula:

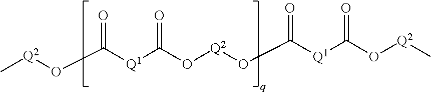

wherein:

Q¹ represents a divalent hydrocarbon-based radical derived from a saturated or unsaturated, linear, branched, cyclic or polycyclic aliphatic, aromatic or aromatic alkyl dicarboxylic acid by replacing each of the two carboxyl groups —COOH with a free valence, said acid having an acid number AN ranging from 120 to 1247 mg KOH/g; and optionally comprising at least one heteroatom (such as for example N, O, S, and in particular 0 and S);

Q² represents a divalent hydrocarbon-based radical derived from a saturated or unsaturated, linear, branched, cyclic or polycyclic aliphatic, aromatic or aromatic alkyl diol by replacing each of the two hydroxyl groups with a free valence, said diol having a hydroxyl number OHN ranging from 120 to 1808 mg KOH/g; and optionally comprising at least one heteroatom (such as for example N, O, S, and in particular 0 and N);
derived from a polybutadiene diol of formula:

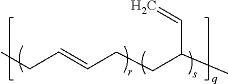

wherein s represents the number of 1,2-vinyl repeating units present at less than 5 mol % in the polybutadiene chain, said percentage being expressed on the basis of the total number of moles of constituent units of the chain, and even more preferably less than 2%;
derived from a hydrogenated polybutadiene diol of formula:

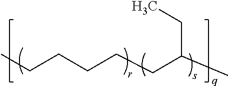

derived from a polyisoprene diol formula:

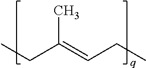

derived from a hydrogenated polyisoprene diol of formula:

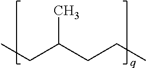

derived from a poly(meth)acrylate diol of formula:

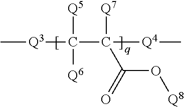

wherein:

Q³ and Q⁴ represent, independently of one another, a divalent linear or branched alkyl, aryl, mercaptoalkyl, ether, ester, carbonate or acrylate radical, preferably having from 1 to 22 carbon atoms, preferably from 1 to 12 carbon atoms, more preferably from 1 to 8 carbon atoms,

Q⁵, Q⁶ and Q⁷ represent, independently of one another, a hydrogen atom or a halogenated, linear, cyclic, alicyclic heterocyclic alkyl or dialkylaminoalkyl radical preferably having from 1 to 22 carbon atoms, preferably from 1 to 12 carbon atoms, and more preferably from 1 to 8 carbon atoms,

Q⁸ represents a saturated or unsaturated, linear or branched, cyclic or alicyclic alkyl radical preferably having from 1 to 22 carbon atoms, preferably from 1 to 12 carbon atoms, more preferably from 1 to 8 carbon atoms, and optionally comprising at least one heteroatom (such as for example N, O, S, and in particular O and N).
The polymer (B) of formula (VII′) wherein r is zero is obtained from the diol of formula:

HO—R⁶—OH
wherein R⁶ is as defined above;
according to process 1.1. described above.
The polymer (B) of formula (VII′) wherein r is non-zero is obtained from the diol of formula:

HO—R⁶—OH
wherein R⁶ is as defined above;
   and from the diisocyanate of formula:

OCN—R⁵—NCO
wherein R⁵ is as defined above
   according to process 1.2.1. described above.
The polymer (B) of formula (VIII′) is obtained from the diol of formula:

HO—R⁶—OH
wherein R⁶ is as defined above;
   and from the diisocyanate of formula:

OCN—R⁵—NCO
wherein R⁵ is as defined above
   according to process 1.2.3. described above.

II—Compound (A) Other than a Polymer and Corresponding Precursor Compound (B):

In addition to the preparation of a polymer compound (A) in accordance with the preferred implementation variant of the process according to the invention which is described above, the present invention also relates to the preparation of a compound (A) with a molar mass of between 170 and 1000 g/mol and corresponding to formula (VI):

M[(X—(C═O)—CH═CH—R¹—Si(R²)ₚ(OR³)₍₃₋ₚ₎]_{f} (VI)

wherein:
M is a linear, branched or cyclic, saturated or unsaturated hydrocarbon-based radical comprising from 1 to 6 free valences and optionally having one or more heteroatoms (such as for example N, O, S, and in particular O) or an ester function or a urethane function or a urea function;
X represents —O— or the group —NR⁴—;
R¹, R², R³, R⁴ and p are as defined above; and
f is an integer ranging from 1 to 6.

Said compound (A) is advantageously obtained, in accordance with the process according to the invention, from a compound (B) of formula (VI′):

M[(X—(C═O)—CH═CH₂]_{f} (VI′)

wherein M is as defined in formula (VI).

In the case where, in accordance with a preferred variant, X represents —O—, the compound of formula (VI′) can be prepared from a monol or from a polyol respectively having a molar mass or a number-average molecular weight (Mn) ranging from 32 to 828 g/mol and of formula:

M(OH)_{f}

by reaction with the chloride of acrylic acid or with an acrylic acid ester, in amounts such that: the OH—C(═O)X′ mole ratio (with X′representing Cl or O) is less than or equal to 1, preferably ranges from 0.90 to 1.00 and preferentially ranges from 0.95 to 1.00.

A very large number of compounds comprising an acrylate function are also commercially available. Mention may for example be made, in a nonlimiting manner, of:
the monofunctional acrylates available from Sartomer, such as (tert-butyl)cyclohexyl acrylate (SR217; 210 g/mol), 2-(2-ethoxyethoxy)ethyl acrylate (SR256; 188 g/mol), tetrahydrofurfuryl acrylate (SR285; 156 g/mol), lauryl acrylate (SR335; 240 g/mol), 2-phenoxyethyl acrylate (SR339C; 192 g/mol), isodecyl acrylate (SR395; 212 g/mol), 3,3,5-trimethyl cyclohexyl acrylate (SR420; 195 g/mol), isooctyl acrylate (SR440; 184 g/mol), octadecyl acrylate (SR484; 200 g/mol), tridecyl acrylate (SR489; 255 g/mol), polycaprolactone acrylate (SR495B; 344 g/mol), ethoxylated (4 OE) nonylphenol acrylate (SR504D; 450 g/mol), isobornyl acrylate (SR506D; 208 g/mol), cyclic trimethylolpropane acrylate (SR531; 200 g/mol), stearyl acrylate (SR586; 324 g/mol) and ethoxylated (4 OE) lauryl acrylate (SR9075; 284 g/mol),
the difunctional acrylates available from Sartomer, such as 1,6-hexanediol diacrylate (SR238; 226 g/mol), tetraethylene glycol diacrylate (SR268G; 320 g/mol), triethylene glycol diacrylate (SR272; 258 g/mol), tripropylene glycol diacrylate (SR306; 300 g/mol), 3-methyl-1,5-pentanediol diacrylate (SR341; 226 g/mol), polyethylene glycol diacrylate (SR344; 508 g/mol), ethoxylated (3 OE) bisphenol A diacrylate (SR349; 424 g/mol), polyethylene glycol diacrylate (SR610; 726 g/mol), dipropylene glycol diacrylate (SR508; 252 g/mol), ethoxylated (5 OE) hexanediol diacrylate (SR561; 446 g/mol), 1,10-decanediol diacrylate (SR595; 282 g/mol), esterdiol diacrylate (SR606A; 312 g/mol), tricyclodecanedimethanol diacrylate (SR833S; 304 g/mol) and propoxylated (2 OP) neopentyl glycol diacrylate (SR9003; 328 g/mol),
the trifunctional acrylates available from Sartomer, such as trimethylolpropane triacrylate (SR351; 296 g/mol), tris(2-hydroxyethyl)isocyanurate triacrylate (SR368; 423 g/mol), ethoxylated (3 OE) trimethylolpropane triacrylate (SR454; 428 g/mol), propoxylated (3 OE) trimethylolpropane triacrylate (SR492; 470 g/mol), ethoxylated (6 OE) trimethylolpropane triacrylate (SR499; 554 g/mol), ethoxylated (9 OE) trimethylolpropane triacrylate (SR502; 692 g/mol), propoxylated (3 OE) glyceryl triacrylate (SR9020; 428 g/mol) and ethoxylated (12 OE) glyceryl triacrylate (SR9046; 782 g/mol),
the tetrafunctional acrylates available from Sartomer, such as pentaerythritol tetraacrylate (SR295; 352 g/mol), ditrimethylolpropane tetraacrylate (SR355; 482 g/mol) and ethoxylated (4 OE) pentaerythritol tetraacrylate (SR494); 528 g/mol),
the pentafunctional acrylates available from Sartomer, such as dipentaerythritol pentaacrylate (SR399; 525 g/mol),
hexafunctional acrylates, such as dipentaerythritol hexaacrylate, the synthesis of which is described in patent application CN 103 127 955 from Beijing University of Technology.

Likewise, in the case where X represents —NR⁴—, the compound (B) of formula (VI′) can be prepared from a monoamine or from a polyamine respectively having a molar mass or a number-average molecular weight (Mn) respectively ranging from 31 to 828 g/mol and of formula:

M(NH—R⁴)f

by reaction with the chloride of acrylic acid or with an acrylic acid ester, in amounts such that: the OH—C(═O)X′ mole ratio (with X′representing Cl or O) is less than or equal to 1, preferably ranges from 0.90 to 1.00 and preferentially ranges from 0.95 to 1.00.

III—Description of the α-Olefinic Silane (C) of Formula (II):

The cross-metathesis reaction is carried out, in accordance with the preparation process according to the invention, in the presence of the compound (B) described above and of the α-olefinic silane (C) of formula (II):

H₂C═CH—R¹—Si(R²)ₚ(OR³)₍₃₋ₚ₎ (II)

This compound (C) can be obtained according to the procedure described in the application.

JP 1,158,482 from Shin-Etsu Chemical by dehydrochlorination, in the presence of a diazabicycloalkene, of a chloroalkylalkoxysilane of formula:

Cl—CH₂—R¹—Si(R²)ₚ(OR³)₍₃₋ₚ₎

This chloroalkylalkoxysilane precursor is conventionally obtained by hydrosilylation of an olefinic 1-chloroalkene precursor.

According to one preferred embodiment, the divalent radical R¹ is a radical of formula —(CH₂)ₙ— wherein n is an integer ranging from 1 to 9.

More preferably, the α-olefinic silane (C) is such that R¹ is —CH₂, and, even more preferably, is allyl trimethoxysilane.

Other processes for obtaining such silane compounds are also described, for example, in patent JPS 5751400 from Shin-Etsu Chemical, or in patent applications JP 3128192 from Shin-Etsu Chemical and EP 1549657 from Dow Corning which describe more specifically the obtaining of the compounds (C) of trialkoxysilane type.

Allyl trimethoxysilane is also commercially available from the American companies Sigma-Aldrich and Kingston Chemistry.

IV—Description of the Metathesis Catalyst (D):

The metathesis catalyst (D) is chosen from the 2nd-generation Grubbs catalyst (G2) of formula:

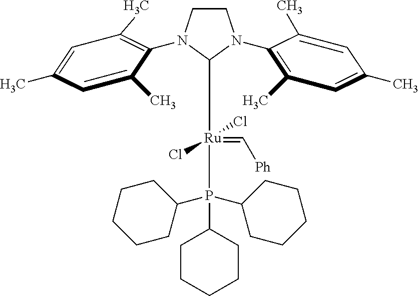

and the 2^{nd}-generation Hoveyda-Grubbs catalyst (HG2) of formula:

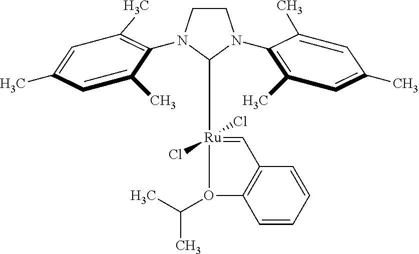

The IUPAC name of (G2) is benzylidene [1,3-bis(2,4,6-trimethylphenyl)-2-imidazolidinylidene]dichloro(tricyclohexylphosphine)ruthenium (CAS number 246047-72-3). This catalyst is available from Sigma-Aldrich.

The IUPAC name of (HG2) is (1,3-bis-(2,4,6-trimethylphenyl)-2-imidazolidinylidene)dichloro(o-isopropoxyphenylmethylene)ruthenium (CAS number: 301224-40-8). This catalyst is available from Sigma-Aldrich.

According to a very particularly preferred variant of the process according to the invention, the metathesis catalyst (D) is the catalyst (HG2). A particularly high degree of conversion, ranging from 90% to 100%, of the acrylate or acrylamide group(s) F′ of compound (B) into an alkoxysily group F of formula (I) is then advantageously obtained.

V—Conditions for Carrying Out the Cross-Metathesis Reaction:

The duration and the temperature of the cross-metathesis reaction depend generally on its operating conditions, especially on the nature of the solvent used and in particular on the content of catalytic filler. Those skilled in the art are capable of adjusting them as a function of the circumstances.

Thus, the cross-metathesis reaction is advantageously carried out under a light stream of nitrogen or argon (to remove the ethylene which forms) for a period ranging from 2 to 24 hours, preferably from 3 to 8 hours, and at a temperature in a range of from 20 to 60° C., preferably from 30 to 40° C.

The amounts of α-olefinic silane (C) and of precursor compound (B) used are generally such that the ratio r⁶ equal to the ratio of the number of moles of said silane (C) to the number of moles (or molar equivalents) of H₂C═CH—C(O)X— functions of the compound (B) is within a range extending from 1 to 1.20, preferably extending from 1.05 to 1.18.

The amount of metathesis catalyst (D) used is such that the ratio r⁷ equal to the ratio of the number of moles (or molar equivalents) of H₂C═CH—C(O)X— functions of the compound (B) to the number of moles (or molar equivalents) of catalyst (D) is within a range extending from 300 to 10 000, preferably from 4000 to 6000. The catalyst can be added once or several times.

The progression of the reaction, and more particularly the disappearance and conversion of the acrylate function, are monitored by 1H/¹³C NMR.

The solvent used in the reaction is generally chosen from the group formed by the aqueous or organic solvents typically used in polymerization reactions and which are inert under the polymerization conditions, such as aromatic hydrocarbons, chlorinated hydrocarbons, ethers, aliphatic hydrocarbons, alcohols, water or mixtures thereof.

A preferred solvent is chosen from the group formed by benzene, toluene, para-xylene, methylene chloride (or dichloromethane), 1,2-dichloroethane, dichlorobenzene, chlorobenzene, tetrahydrofuran, diethyl ether, pentane, hexane, heptane, a mixture of liquid isoparaffins (for example Isopar®), methanol, ethanol, water or mixtures thereof.

Even more preferably, the solvent is chosen from the group formed by benzene, toluene, para-xylene, methylene chloride, 1,2-dichloroethane, dichlorobenzene, chlorobenzene, tetrahydrofuran, diethyl ether, pentane, hexane, heptane, methanol, ethanol or mixtures thereof.

Even more particularly preferably, the solvent is dichloromethane, 1,2-dichloroethane, toluene, heptane or a mixture of toluene and 1,2-dichloroethane.

A subject of the present invention is also the compound (A) comprising at least one alkoxysilyl group F of formula (I):

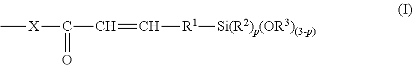

wherein:
X represents —O— or the group —NR⁴— wherein R⁴ represents a hydrogen atom or an alkyl radical comprising from 1 to 20 carbon atoms, preferably from 1 to 4 carbon atoms;
R¹ is a linear or branched, saturated or unsaturated hydrocarbon-based radical comprising from 1 to 20 carbon atoms, preferably from 1 to 9 carbon atoms and even more preferentially from 1 to 2 carbon atoms;
R² represents a linear or branched alkyl radical comprising from 1 to 4 carbon atoms, with the possibility that, when there are several radicals R², these radicals are identical or different;
R³ represents a linear or branched alkyl radical comprising from 1 to 4 carbon atoms, with the possibility that, when there are several radicals R³, these radicals are identical or different, and with the possibility, in addition, that two groups OR³ may be engaged in the same ring;
p is an integer equal to 0, 1 or 2, preferably equal to 0 or 1.

Compound (A) can be prepared by means of the process which is the subject of the invention and described above.

According to one preferred variant, the compound (A) is capable of being obtained by the process as defined above and which is the subject of the present invention.

According to a particularly preferred variant, the compound (A) is a polymer of which the main chain is chosen:
when X is —O—, from a polyether, a polyester, a polyene, a poly(meth)acrylate or a polyurethane; and
when X is the group —NR⁴—, from a polyether, a polyene, a poly(meth)acrylate or a polyurethane;
   and which comprises at least one group F of formula (I), which is preferably an end group, and more preferably 2 end groups F.

According to one preferred embodiment, the polymer (A) is such that R¹ is a hydrocarbon-based radical comprising from 1 to 2 carbon atoms. Said polymer then advantageously exhibits, when it is included in an adhesive composition, an improved reactivity, corresponding to a reduced crosslinking time with atmospheric moisture.

According to another preferred embodiment, the polymer (A) is a polyurethane which comprises at least one end group F and preferably 2 end groups F corresponding to one of the following formulae:

—O(C═O)—CH═CH—R¹—Si(R²)ₚ(OR³)₍₃₋ₚ₎ (I)-1

—O(C═O)—NH—R^{O}—O(C═O)—CH═CH—R¹—Si(R²)ₚ(OR³)₍₃₋ₚ₎ (I)-2

—NH(C═O)—O—R^{O}—O(C═O)—CH═CH—R¹—Si(R²)ₚ(OR³)₍₃₋ₚ₎ (I)-3

—NH(C═O)—O—R^{N}—NR⁴—(C═O)—CH═CH—R¹—Si(R²)ₚ(OR³)₍₃₋ₚ₎ (I)-5.

wherein R¹, R², R³, R⁴, R^{O}, R′^{O} and R^{N} are as defined above.

The compound (A) corresponding to formulae (I)-1, (I)-2, (I)-3 and (I)-5 above can be prepared in accordance with the processes described above in points 1.2. and 2.2.

According to an even more preferred embodiment, the polyurethane (A) corresponds to one of formulae (VII) and (VIII):

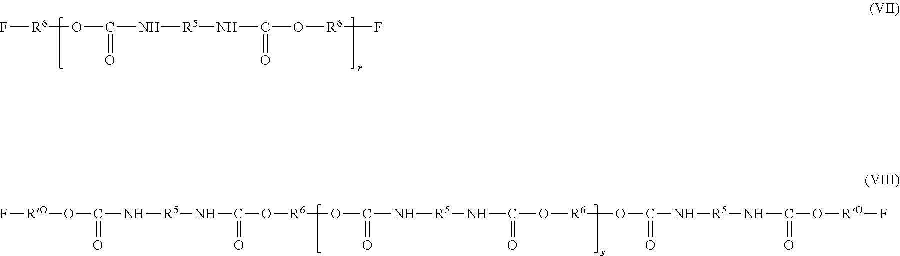

wherein:
F is the alkoxysilyl group of formula (I)-1:

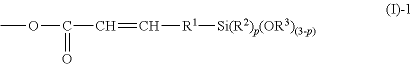

R⁵ represents a divalent hydrocarbon-based radical comprising from 5 to 15 carbon atoms which can be aromatic or aliphatic and linear, branched or cyclic;
R⁶ represents a saturated or unsaturated, linear or branched divalent hydrocarbon-based radical optionally comprising one or more oxygen atoms;
R′^{O} is the radical as defined above;
r is an integer greater than or equal to 0;
s is an integer strictly greater than 0.

The examples that follow are given purely by way of illustration of the invention and should not be interpreted in order to limit the scope thereof.

### EXAMPLE 1: CROSS-METATHESIS OF TRIPROPYLENE GLYCOL DIACRYLATE (COMPOUND (B)) IN THE PRESENCE OF ALLYL TRIMETHOXYSILANE (COMPOUND (C)) AND OF THE HG2 CATALYST (COMPOUND (D))

Use is made of tripropylene glycol diacrylate (molar mass 300 g/mol, commercially available under the name SR 306 from Sartomer), and, as compound (C), allyl trimethoxysilane having the following formula:

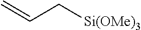

The tripropylene glycol diacrylate (1.7 mmol), purified beforehand on neutral silica, is introduced into a 10 ml round-bottomed flask in which a Teflon®-coated magnetic stirring bar has been placed.

Allyl trimethoxysilane (4.0 mmol) is then added with stirring to the round-bottomed flask by means of a syringe under an argon atmosphere. The ratio r⁶ of the reagents, as defined previously, is equal to 4.0 mmol divided by (2×1.7 mmol), i.e. 1.17.
Then, a solution of Hoveyda-Grubbs (HG2) catalyst (0.57 μmol or 0.57×10−3 mmol) in dry CH₂Cl₂ (3 ml) is then added in 3 batches at 40 minute intervals. The ratio r⁷, as defined above, is equal to (2×1.7 mmol) divided by (0.57×10−3 mmol) i.e. 5965.

The round-bottomed flask and its contents are placed under argon and then immersed in an oil bath at 40° C. for 2 hours in order to remove from the reaction medium the ethylene which is generated by the cross-metathesis reaction. The round-bottomed flask and its contents are then brought to 80° C. under reduced pressure for 1 hour in order to remove the excess unreacted allyl trimethoxysilane.

After 3 hours, counting from the addition of the catalyst, the product present in the round-bottomed flask is extracted after evaporation of the solvent under vacuum. The product is then recovered in the form of a colorless liquid without any purification, with a yield of 99% of isolated product (corresponding to the mixture of disilylated and monosilylated compounds) and a degree of conversion of the acrylate functions of 92%.
Analysis by ¹H/¹³C NMR gives the following results:

¹H NMR (400 MHz, CDCl₃, 293 K) δ (ppm)=7.00 (dt, J=15, 10 Hz, CH₂CH═CH, 1H), 5.79 (d, J=15 Hz, CH₂CH═CH, 1H), 5.05 (bm, CH(CH₃)O(C═O), 1H), 4.06; 3.67 (bm, CH(CH₃)OCH₂CH(CH₃)O(C═O), 1H) overlapping with 4.06 (s, CH₂O(C═O), 2H), 4.00; 3.80 (bm, CH(CH₃)CH₂O(C═O), 1H), 3.55 (s, CH₃OSi, 18H), 3.53 (s, CH₂OCH(CH₃)CH₂O(C═O), 2H), 3.39 (m, CH₂CH(CH₃)O(C═O), 2H), 1.81 (dd, J=8, 5 Hz, CH₂CH═CH, 2H), 1.22 (d, J=6 Hz, CH(CH₃)O(C═O), 3H), 1.14 (bm, CH(CH₃)CH₂O(C═O), 3H), 1.09 (bm, CH(CH₃)OCH₂CH(CH₃)O(C═O), 3H).

¹³C{¹H} NMR (100 MHz, CDCl₃, 293 K) δ (ppm)=166.3, 166.0, 144.8, 144.5, 121.7, 120.8, 76.0, 75.2, 73.6, 72.2, 69.5, 67.2, 53.6, 51.2, 21.2, 17.8, 16.9. FT-IR v (cm⁻¹)=2970 (C═C—H stretch, alkene), 1710 (C═O stretch, ester), 1640 (C═C stretch, alkene), 1070 (C—O stretch), 810 (═C—H bend, alkene), 770 (═C—H bend, alkene). ESI-MS [M⁺Na⁻] (C₂₃H₄₄O₁₂NaSi₂), z=1, m/z_{calculated}=591.22635, m/zₑₓₚₑᵣᵢₘₑₙₜₐₗ=591.2267.

These values confirm the majority presence of the disilylated compound (A) of the following structure:

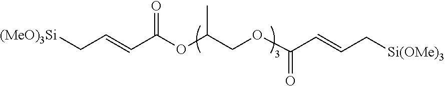

and the minority presence of the monosilylated compound of the following structure:

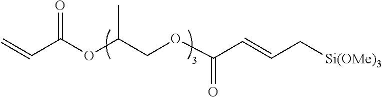

### EXAMPLE 2: CROSS-METATHESIS OF TRIPROPYLENE GLYCOL DIACRYLATE (COMPOUND (B)) IN THE PRESENCE OF ALLYL TRIMETHOXYSILANE (COMPOUND (C)) AND OF THE G2 CATALYST (COMPOUND (D))

Example 1 is repeated, replacing the HG2 catalyst with the G2 catalyst.

The same product is obtained, with a yield of 95% of isolated product and a degree of conversion of the acrylate functions of 70%.

### EXAMPLE 3: CROSS-METATHESIS OF A POLYURETHANE DIACRYLATE (POLYMER (B)) IN THE PRESENCE OF ALLYL TRIMETHOXYSILANE (COMPOUND (C)) AND OF THE HG2 CATALYST (COMPOUND (D))

Step 1: Synthesis of Polyurethane Diacrylate:

A polyurethane diacrylate is synthesized in 2 steps according to the following procedure:

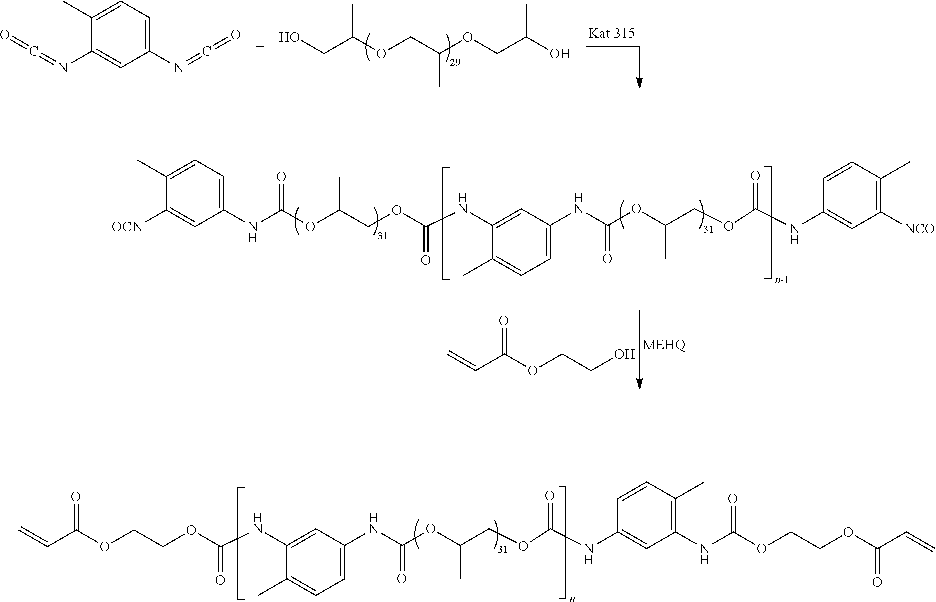

1163 g of polypropylene glycol (0.58 mol) having a number-average molecular weight (Mn) equal to 1800 g/mol, 201 g of 2,4-toluene diisocyanate (1.15 mol), and 1.4 g of Borchi® Kat 315 catalyst (commercially available from Borchers) are successively introduced into a 2-liter reactor.

The mixture is heated at 80° C. until total consumption of the —OH functions corresponding to the obtaining of a polyurethane comprising —NCO end groups, having an NCO % of 3.2% by weight. 1.4 g of hydroquinone monomethyl ether (MEHQ-polymerization inhibitor) then 132 g of 2-hydroxyethyl acrylate (1.02 mol) are then introduced into the reaction medium in a stoichiometric mole ratio relative to the —NCO functions of the polyurethane comprising —NCO end groups, previously obtained. The mixture is maintained at 80° C. with stirring until complete disappearance of the —NCO functions by infrared.

Step 2: Cross-Metathesis of Polyurethane Diacrylate:

Use is made of the polyurethane diacrylate from step 1, and, as compound (C), allyl trimethoxysilane having the following formula:

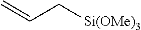

Polyurethane diacrylate (10.0 mmol) and dry CH₂Cl₂ (17 ml) are introduced into a 50 ml round-bottomed flask in which a Teflon®-coated magnetic stirring bar has also been placed.

Allyl trimethoxysilane (21.0 mmol) is then added with stirring to the round-bottomed flask by means of a syringe under an argon atmosphere. The ratio r⁶ of the reagents, as defined above, is equal to 21.0 mmol divided by (2×10.0 mmol), i.e. 1.05.

Then a solution of Hoveyda-Grubbs (HG2) catalyst (0.05 mmol) in dry CH₂Cl₂ (3 ml) is subsequently added in 3 batches at 40 minute intervals. The ratio r⁷, as defined above, is equal to 20.0 mmol divided by 0.05 mmol, i.e. 400.

The round-bottomed flask and its contents are placed under argon and then immersed in an oil bath at 40° C. for 2 hours in order to remove from the reaction medium the ethylene generated by the cross-metathesis. The round-bottomed flask and its contents are then brought to 80° C. under reduced pressure for 1 hour in order to remove the excess unreacted allyl trimethoxysilane.

After 3 hours, counting from the addition of the catalyst, the product present in the round-bottomed flask is extracted after evaporation of the solvent under vacuum. The product is then recovered in the form of a colorless liquid without any purification, with a yield of 99% of isolated product and a degree of conversion of the acrylate functions of 96%.

Analysis by 1H/¹³C NMR gives the following results:

¹H NMR (400 MHz, CDCl₃, 293 K) δ (ppm)=7.67 (bs, C(NH)═CH═C(NH), 1H), 7.41-7.22 (bs, NH, 1H), 7.13 (bd, CH═CH═C(NH), 1H), 6.95 (bd, CH═CH═C(NH), 1H), 6.95 (bd, CH═CHCH₂Si(OCH₃)₃, 1H), 6.64 (bs, NH, 1H), 5.74 (bdd, CH═CHCH₂Si(OCH₃)₃, 1H), 4.90 (bm, CH(CH₃)O(C═O)), 4.27 (bs, OCH₂CH₂O, 4H), 3.60-3.37 (bm, CH(CH₃)O(C═O)), 3.47 (s, Si(OCH₃)₃), 3.31 (bd, CH₂CH(CH₃)O(C═O), 2.09 (s, C(CH₃)CH═CH═C(NH), 3H), 1.74 (bd, CH═CHCH₂Si(OCH₃)₃, 2H), 1.19 (bs, CH(CH₃)O(C═O)), 1.03 (bs, CH(CH₃)O(C═O)).

¹³C{¹H} NMR (100 MHz, CDCl₃, 293 K) δ (ppm)=166.0, 153.1, 145.3, 137.0, 135.9, 130.5, 120.5, 114.5, 111.9, 175.0, 73.2, 70.3, 63.0, 62.1, 50.7, 17.1, 16.9. FT-IR v (cm⁻¹)=3300 (N—H stretch, amide), 2970 (C═C stretch), 1720 (C═O stretch, ester), 1080 (C—O stretch).

These values confirm the majority presence of the disilylated compound of the following structure:

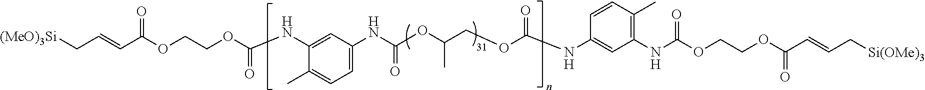

and the minority presence of the monosilylated compound of the following structure:

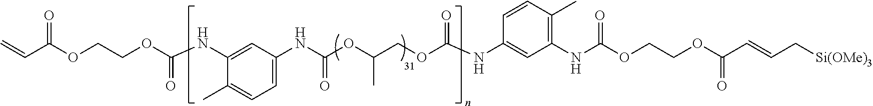

### EXAMPLE 4: CROSS-METATHESIS OF A POLYPROPYLENE GLYCOL DIACRYLATE (POLYMER (B)) IN THE PRESENCE OF ALLYL TRIMETHOXYSILANE (COMPOUND (C)) AND OF THE HG2 CATALYST (COMPOUND (D))

Step 1: Synthesis of Polypropylene Glycol Diacrylate:

A polyurethane diacrylate is synthesized in one step according to the following procedure:

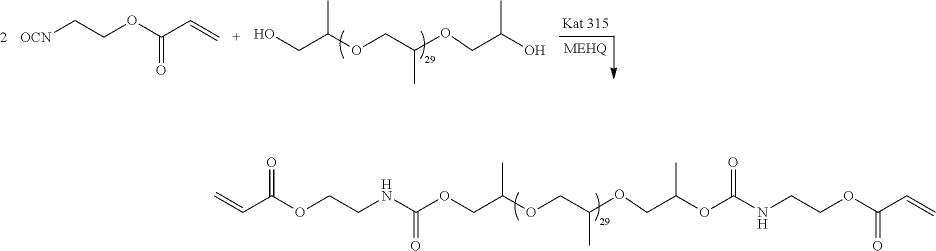

1163 g of polypropylene glycol (0.58 mol) having a number-average molecular weight (Mn) equal to 1800 g/mol, 164 g of 2-isocyanatoethyl acrylate (1.16 mol), 1.4 g of hydroquinone monomethyl ether (MEHQ-polymerization inhibitor), then 1.4 g of Borchi® Kat 315 catalyst (commercially available from Borchers) are successively introduced into a 2-liter reactor, and the mixture is heated at 80° C. until complete disappearance of the —NCO functions by infrared.

Step 2: Cross-Metathesis of Polypropylene Glycol Diacrylate:

Step 2 of example 3 is repeated, replacing the polyurethane diacrylate with the polypropylene glycol diacrylate obtained in step 1.

A product is obtained which is recovered in the form of a colorless liquid without any purification, with a yield of 99% of isolated product and a degree of conversion of the acrylate functions of 98%.

¹H/¹³C NMR analysis confirms the majority presence of the disilylated compound of the following structure:

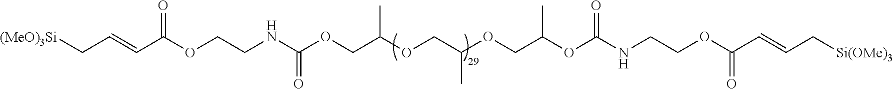

and the minority presence of the monosilylated product of the following structure:

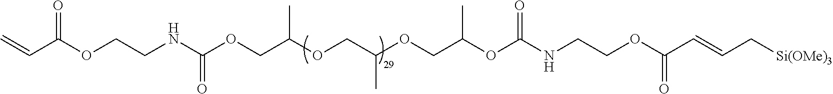

### EXAMPLE 5: CROSS-METATHESIS OF A POLYISOPRENE DIOL DIACRYLATE (POLYMER (B)) IN THE PRESENCE OF ALLYL TRIMETHOXYSILANE (COMPOUND (C)) AND OF THE HG2 CATALYST (COMPOUND (D))

Saturated polyisoprene diol diacrylate (PIPA available from San Esters) is used, and allyl trimethoxysilane of the following formula is used as transfer agent:

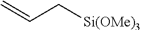

The saturated polyisoprene diol diacrylate (10.0 mmol) having a number-average molecular weight (Mn) equal to 2700 g/mol and dry CH₂Cl₂ (17 ml) are introduced into a 50 ml round-bottomed flask in which a Teflon®-coated magnetic stirring bar has been placed.

Allyl trimethoxysilane (21.0 mmol) is then added with stirring to the round-bottomed flask by means of a syringe under an argon atmosphere. The ratio r⁶ of the reagents, as defined above, is equal to 21 mmol divided by (2×10.0 mmol), i.e. 1.05.

Then a solution of Hoveyda-Grubbs (HG2) catalyst (0.05 mmol) in dry CH₂Cl₂ (3 ml) is subsequently added in 3 batches at 40 minute intervals. The ratio r⁷, as defined above, is equal to 20.0 mmol divided by 0.05 mmol, i.e. 400.

The round-bottomed flask and its contents are placed under argon and then immersed in an oil bath at 40° C. for 2 hours in order to remove from the reaction medium the ethylene generated by the cross-metathesis. The round-bottomed flask and its contents are then brought to 80° C. under reduced pressure for 1 hour in order to remove the excess unreacted allyl trimethoxysilane.

After 3 hours, counting from the addition of the catalyst, the product present in the round-bottomed flask is extracted after evaporation of the solvent under vacuum. The product is then recovered in the form of a colorless liquid without any purification, with a yield of 99% of isolated product and a degree of conversion of the acrylate functions of 96%.

As for the previous examples, the ¹H/¹³C MR analysis confirms the majority presence of the disilylated compound of the following structure:

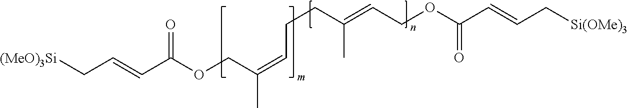

and the minority presence of the compound product of the following structure:

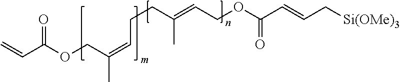

1. A process for preparing a compound (A) comprising at least one alkoxysilyl group F of formula (I): 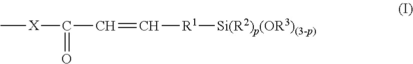
wherein:
X represents —O— or the group —NR⁴— wherein R⁴ represents a hydrogen atom or an alkyl radical comprising from 1 to 20 carbon atoms, preferably from 1 to 4 carbon atoms;
R¹ is a linear or branched, saturated or unsaturated hydrocarbon-based radical comprising from 1 to 20 carbon atoms, preferably from 1 to 9 carbon atoms and even more preferentially from 1 to 2 carbon atoms;
R² represents a linear or branched alkyl radical comprising from 1 to 4 carbon atoms, with the possibility that, when there are several radicals R², these radicals are identical or different;
R³ represents a linear or branched alkyl radical comprising from 1 to 4 carbon atoms, with the possibility that, when there are several radicals R³, these radicals are identical or different, and with the possibility, in addition, that two groups OR³ may be engaged in the same ring;
p is an integer equal to 0, 1 or 2, preferably equal to 0 or 1;
said process comprising a cross-metathesis reaction in the presence of:
(i) a compound (B) comprising at least one acrylate or acrylamide group F′ of formula (I′):
—X(C═O)—CH═CH₂ (I′)
wherein X is as defined above;
(ii) an α-olefinic silane (C) of formula (II):
H₂C═CH—R¹—Si(R²)ₚ(OR³)₍₃₋ₚ₎ (II);
wherein R¹, R² and R³ are as defined above; and
(iii) a metathesis catalyst (D) chosen from the 2^{nd}-generation Grubbs catalyst (G2) of formula: 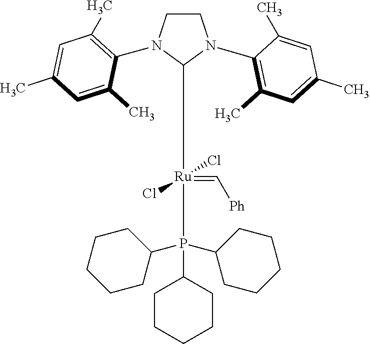
and the 2^{nd}-generation Hoveyda-Grubbs catalyst (HG2) of formula:

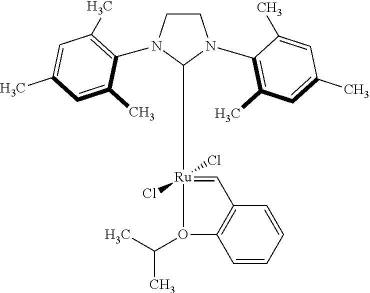

2. The preparation process as claimed in claim 1, characterized in that the compound (A) is a polymer of which the main chain is chosen:
when X is —O—, from a polyether, a polyester, a polyene, a poly(meth)acrylate or a polyurethane; and
when X is the group —NR⁴—, from a polyether, a polyene, a poly(meth)acrylate or a polyurethane;
which is obtained from a polymer (B) of which the main chain is identical to that of the polymer (A).

3. The preparation process as claimed in claim 2, characterized in that the polymer (A) comprises 2 end groups F of formula (I) and in that the polymer (B) comprises 2 end groups F′ of formula (I′).

4. The preparation process as claimed in claim 2, characterized in that the main chain of the polymers (A) and (B) is a polyurethane chosen from a polyether-polyurethane, a polyester-polyurethane, a polyether-polyester-polyurethane, a polyene-polyurethane, a polyether-polyene-polyurethane or a poly(meth)acrylate-polyurethane.

5. The preparation process as claimed in claim 2, characterized in that the polymer (A) and the precursor polymer (B) have a polyurethane as their main chain and comprise 2 end groups, respectively F of formula (I) and F′ of formula (I′), wherein X represents —O—.

6. The preparation process as claimed in claim 5, characterized in that the polyurethane (A) corresponds to one of the formulae (VII) and (VIII): 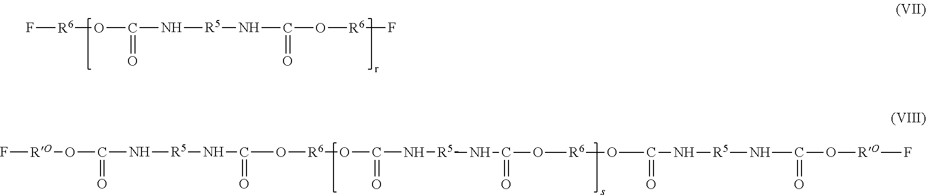
and the precursor polyurethane (B) corresponds, respectively, to one of the following formulae (VII′) and (VIII′): 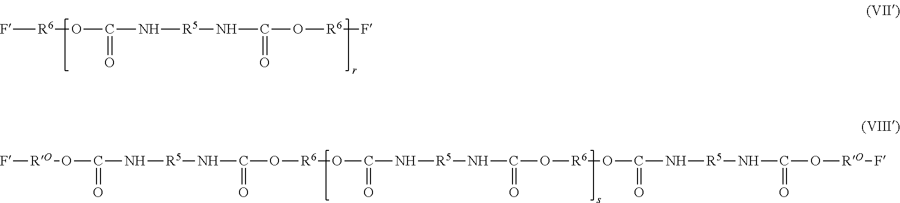
wherein:
F is the alkoxysilyl group of formula (I)-1: 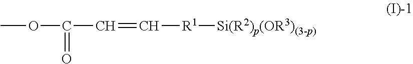
F′ is the acrylate group;
R⁵ represents a divalent hydrocarbon-based radical comprising from 5 to 15 carbon atoms which can be aromatic or aliphatic and linear, branched or cyclic;
R⁶ represents a saturated or unsaturated, linear or branched divalent hydrocarbon-based radical optionally comprising one or more oxygen atoms;
R′^{O} represents a linear or branched, aliphatic or cyclic, saturated or unsaturated divalent BOSTIK-0060 alkylene radical comprising from 2 to 6 carbon atoms;
r is an integer greater than or equal to 0;
s is an integer strictly greater than 0.

7. The preparation process as claimed in claim 1, characterized in that the compound (A) has a molar mass of between 170 and 1000 g/mol and corresponds to formula (VI):
M[(X—(C═O)—CH═CH—R¹—Si(R²)ₚ(OR³)₍₃₋ₚ₎]_{f} (VI)
wherein:
M is a linear, branched or cyclic, saturated or unsaturated hydrocarbon-based radical comprising from 1 to 6 free valences and optionally having one or more heteroatoms or an ester function or a urethane function or a urea function; and
f is an integer ranging from 1 to 6;
and the compound (B) corresponds to formula (VI′):
M[(X—(C═O)—CH═CH₂]_{f} (VI′)
wherein M is as defined in formula (VI).

8. The preparation process as claimed in claim 1, characterized in that the metathesis catalyst (D) is the catalyst (HG2).

9. A compound (A) comprising at least one alkoxysilyl group F of formula (I): 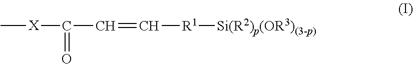
wherein:
X represents —O— or the group —NR⁴— wherein R⁴ represents a hydrogen atom or an alkyl radical comprising from 1 to 20 carbon atoms, preferably from 1 to 4 carbon atoms;
R¹ is a linear or branched, saturated or unsaturated hydrocarbon-based radical comprising from 1 to 20 carbon atoms, preferably from 1 to 9 carbon atoms and even more preferentially from 1 to 2 carbon atoms;
R² represents a linear or branched alkyl radical comprising from 1 to 4 carbon atoms, with the possibility that, when there are several radicals R², these radicals are identical or different;
R³ represents a linear or branched alkyl radical comprising from 1 to 4 carbon atoms, with the possibility that, when there are several radicals R³, these radicals are identical or different, and with the possibility, in addition, that two groups OR³ may be engaged in the same ring;
p is an integer equal to 0, 1 or 2, preferably equal to 0 or 1.

10. The compound (A) as claimed in claim 9, produced by a process comprising a cross-metathesis reaction in the presence of:
(i) a compound (B) comprising at least one acrylate or acrylamide group F′ of formula (I′):
—X(C═O)—CH═CH₂ (I′)
wherein X is as defined above;
(ii) an α-olefinic silane (C) of formula (II):
H₂C═CH—R¹—Si(R²)ₚ(OR³₍₃₋ₚ₎ (II):
wherein R¹, R² and R³ are as defined above; and
(iii) a methathesis catalyst (D) chosen from the 2^{nd}-generation Grubbs catalyst (G2) of formula: 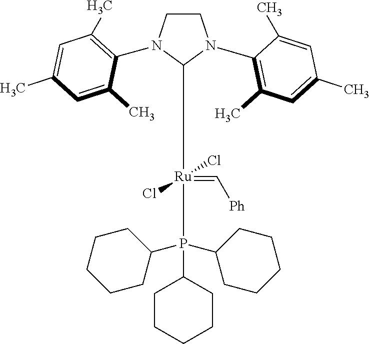
and the 2^{nd}-generation Hoveyda-Grubbs catalyst (HG2) of formula:

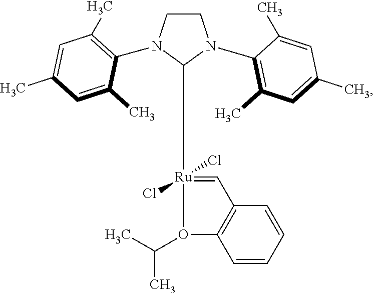

11. The compound (A) as claimed in claim 9, characterized in that it is a polymer of which the main chain is chosen:
when X is —O—, from a polyether, a polyester, a polyene, a poly(meth)acrylate or a polyurethane; and
when X is the group —NR⁴—, from a polyether, a polyene, a poly(meth)acrylate or a polyurethane;
and which comprises 2 end groups F.

12. The polymer (A) as claimed in claim 11, characterized in that R¹ is a hydrocarbon-based radical comprising from 1 to 2 carbon atoms.

13. The polymer (A) as claimed in claim 11, characterized in that it is a polyurethane which comprises 2 end groups F corresponding to one of the following formulae:
—O(C═O)—CH═CH—R¹—Si(R²)ₚ(OR³)₍₃₋ₚ₎ (I)-1
—O(C═O)—NH—R^{O}—O(C═O)—CH═CH—R¹—Si(R²)ₚ(OR³)₍₃₋ₚ₎ (I)-2
—NH(C═O)—O—R′^{O}—O(C═O)—CH═CH—R¹—Si(R²)ₚ(OR³)₍₃₋ₚ₎ (I)-3
—NH(C═O)—O—R^{N}—NR⁴—(C═O)—CH═CH—R¹—Si(R²)ₚ(OR³)₍₃₋ₚ₎ (I)-5.
wherein R^{O}, R′^{O} and R^{N} are identical or different and represent a linear or branched, aliphatic or cyclic, saturated or unsaturated divalent hydrocarbon-based radical, preferably comprising from 2 to 24 carbon atoms, and being optionally interrupted by one or more heteroatoms.

14. The polymer (A) as claimed in claim 13, characterized in that it corresponds to one of formulae (VII) and (VIII): 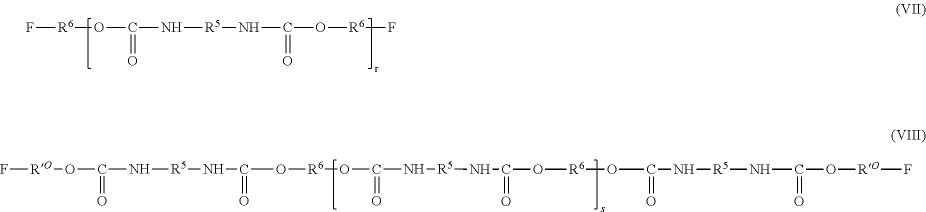
wherein:
F is the alkoxysilyl group of formula (I)-1: 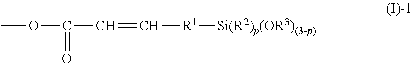
R⁵ represents a divalent hydrocarbon-based radical comprising from 5 to 15 carbon atoms which can be aromatic or aliphatic and linear, branched or cyclic;
R⁶ represents a saturated or unsaturated, linear or branched divalent hydrocarbon-based radical optionally comprising one or more oxygen atoms;
r is an integer greater than or equal to 0;
s is an integer strictly greater than 0.
